(19) United States
(12) Patent Application Publication
(10) Pub. No.: US 2015/0353322 A1
(43) Pub. Date: Dec. 10, 2015

(54) ELEVATOR STRUCTURE TEST

(71) Applicants: Gabriela ROIVAINEN, Hyvinkaa (FI); Giovanni HAWKINS, Helsinki (FI); Panu IHALAINEN, Tervakoski (FI); Samuli MÄNTYNEN, Espoo (FI)

(72) Inventors: Gabriela ROIVAINEN, Hyvinkaa (FI); Giovanni HAWKINS, Helsinki (FI); Panu IHALAINEN, Tervakoski (FI); Samuli MÄNTYNEN, Espoo (FI)

(73) Assignee: KONE CORPORATION, Helsinki (FI)

(21) Appl. No.: 14/826,638

(22) Filed: Aug. 14, 2015

Related U.S. Application Data
(63) Continuation of application No. PCT/EP2014/053131, filed on Feb. 18, 2014.

(30) Foreign Application Priority Data
Feb. 26, 2013 (EP) 13156727.3

(51) Int. Cl. B66B 5/00; G01H 3/00

(52) U.S. Cl. CPC B66B 5/00; G01H 3/00

(57) ABSTRACT

Loose joints and other defects, such as manufacturing, installation, wearing and other similar defects, are hard to find. Especially in case of passenger elevator it is crucial to find these defects in order to produce safe elevators. Testing can be done using a special test signal that is formed by combining an excitement signal with movement control signal. The test signal causes purposively pulsating or oscillating movement of the elevator car that deviates from the ordinary movement of the elevator. This movement causes noises from loose joints and other defects. The sources of these noises can then be located and the defects can be fixed.

This application is a continuation of PCT International Application No. PCT/EP2014/053131 which has an International filing date of Feb. 18, 2014, and which claims priority to European patent application number 13156727.3 filed Feb. 26, 2013, the entire contents of both of which are incorporated herein by reference.

### FIELD OF THE INVENTION

The invention relates to testing elevator structures.

### BACKGROUND OF THE INVENTION

Elevators are commonly used for moving people and material. Especially in passenger elevators the responsibility of passengers causes a need for high quality testing. Testing and verification are commonly used to determine possible manufacturing and installation defects, such as loose joints, loose electric wires, incorrect spacing of components, detached connectors in electric devices, forgotten tools, and any other defects, that might be caused by improper installation, material problems, or any other human error. Extensive testing is typically done after installation or manufacturing an elevator, however, these defects may also be caused by installed spare parts, wearing, vandalism, or any other reason that has an effect to the elevator after installation. In other words, a defect is a malfunction or behavior that needs to be fixed in order to improve the quality and the quality impression of an elevator.

These defects may cause security risks and inconvenience for passengers. Furthermore, the elevator manufacturer is wishing to manufacture and install elevators at desired quality level in order to give positive image of the manufacturer and products. In addition to the above mentioned problems an elevator having defects has reduced overall reliability, breaks down easier and requires thus more maintenance. Thus, every elevator must be tested extensively before it can be used. The need for testing cannot be overcome by additional security components even if they are commonly used for increasing the overall security of an elevator and the security components do not remove inconveniences caused by defects. Proper testing is performed by a person skilled in the field of elevator installations. Typically this person test drives each installed elevator and determines possible problems by looking and listening. An experienced tester recognizes noises caused by manufacturing or installation defects and can examine possible sources of problems.

The method described above is very dependent on the skills of the person testing an elevator. Furthermore, elevators do not sound always the same so it is quite difficult to build the skill. Testing requires not only listening skill but also skills for causing the noise.

There are also special separate shaker devices that can be used instead of manual testing of an already installed elevator, however, these devices are expensive. Thus, there is a need for reliable and affordable testing method. Furthermore, shaker device has a drawback that the elevator will not be tested in the real operating environment. When a shaker device is used the device is so that the elevator car is shaken in one position and it does not travel through the elevator shaft. Furthermore, the shaking generated by a shaker device is artificial and might be different than in real operating conditions.

### SUMMARY

The invention discloses a mechanism for testing elevators by using already installed elevator hoisting equipment. Loose joints and defects, such as the defects mentioned in the background of the invention section, are hard to find. Especially in case of passenger elevator it is crucial to find these defects in order to produce safe elevators. Testing can be done using a special excitement signal, which is combined with ordinary movement control signal controlling movements of the elevator. As a result of the combination a test signal is achieved. The movement control signal is the signal that instructs the elevator to move in accordance with the selections made by passengers. The test signal causes pulsating or oscillating movement of the elevator car that deviates from the ordinary movements of the elevator. This movement causes sounds or noises from loose joints and other defects. The sources of these noises can then be located and the defects can be fixed.

In an embodiment the invention is implemented as a testing method. In the method an excitement signal is first transmitted to the controlling unit of the elevator separately or as a part of a test signal that has been created by combining an excitement signal and movement control signal. Transmitting can be done during manufacturing of the elevator or it can be loaded before testing, for example, from a computer or memory stick of the maintenance person. The excitation signal comprises causes pulsating and/or oscillating movement of the elevator car of the elevator by using the hoisting installation of the elevator. Then noises caused by defects are detected during the excitement.

In an embodiment of the invention an elevator comprises a hoisting installation and elevator car. The hoisting installation is configured control the movement of the elevator in accordance with a test signal described above and further configured to cause pulsating and/or oscillating movement of the elevator car of the elevator in accordance with said test signal. As in the embodiment described above, the movement causes noises from loose joints and other possible sources of defects as discussed above. The sources of these noises can then be located and the defects can be fixed.

In a further embodiment of the invention a computer program comprising code adapted to cause receiving a test signal as described above, wherein said test signal comprises instructions for causing pulsating and/or oscillating movement of the elevator car of an elevator by using and instructing the hoisting installation of said elevator to cause said pulsating and/or oscillating movement, is disclosed.

A benefit of the present invention is that it provides reliable and repeatable testing procedure. The movement in accordance with the excitation signal causes noises deriving from defects. When the maintenance person uses always the same excitation signal he or she can learn to distinguish ordinary noises from unwanted noises caused by defects.

A benefit of the invention is that it can be implemented by using conventional elevator components that are already in place. Every elevator comprises a hoisting installation for moving the elevator and the hoisting installations are able to receive instructions from external devices.

A further benefit of the invention is that the elevator can be tested under real operating conditions. The elevator is first installed into the shaft and then the elevator can be tested in different locations of the shaft. This facilitates, for example, testing of guide rails that is complicated to be tested with a shaker device.

A further benefit of the invention is that the person testing the elevator can do observations in real operating conditions inside the elevator car. Thus, in addition to measured noises the person is able to observe/feel/sense sources of possible problems. Furthermore, the person travelling in the elevator car observes the same in conveniences as an ordinary passenger. Based on this information these inconveniences can be removed.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an example embodiment of the invention,

FIG. 2 is a block diagram of an example embodiment of the present invention,

FIG. 3 is a flow chart of a method according to the present invention.

### DETAILED DESCRIPTION OF THE INVENTION

Reference will now be made in detail to the embodiments of the present invention, examples of which are illustrated in the accompanying drawings.

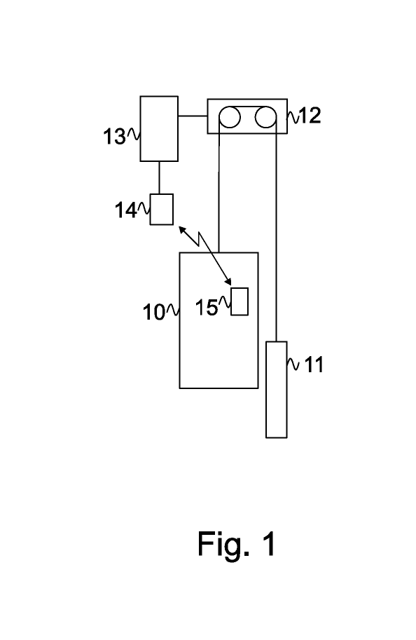

In FIG. 1 a block diagram of an embodiment of the present invention is disclosed. In the figure a conventional elevator is illustrated. The elevator comprises an elevator car 10, a counterweight 11 and hoisting installation 12. The elevator is installed in an elevator shaft. Typically the hoisting installation 12 is driven by an electrical motor. Hoisting installation is controlled by a controller 13. In an ordinary use the controller is configured to receive instructions from elevator controls that are used by the users of the elevator by calling an elevator and choosing a destination. As a response to these requests the controller 13 produces a control signal for controlling the ordinary movement of an elevator. The control signal comprises information necessary to accelerate and decelerate the elevator car so that that the called journey is performed. The controller may be configured to receive instructions from other locations, for example, from a service center or maintenance crew. The controller 13 may be accessed directly or over a network connection. In the example of FIG. 1 the controller 13 is connected to a network switch 14, which is further connected to public or private network. A maintenance person is using his portable device 15 in the elevator. The portable device is wirelessly connected to the network switch 14. The wireless connection may be wireless local area network connection or a connection over a mobile communication network. An alternative for wireless connection is a wired connection, wherein the maintenance person connects device 15 to the elevator car, for example, by using USB (Universal Serial Bus), or any other suitable connecting means.

In FIG. 1 hoisting installation 12 and controller 13 are located in accordance with the need of the complete installation. There is a plurality of options that vary based on elevator properties, such as height, size, space requirements and similar properties.

In the embodiment of the figure hoisting installation comprises variable frequency drive and an electrical motor. The elevator is then operated according to the instructions received from the controller 13 as discussed above. When the elevator is to be tested, for example after installation or after yearly maintenance, the maintenance person connects the device 15 to the controller 13 over networks switch 14. Then the maintenance person instructs the controller to use a special purpose test sequence for moving the elevator. The sequence may comprise ordinary movement between floors but it also includes a special purpose excitement signal for causing pulsating or oscillating movement created with the variable frequency drive is used. The actual excitement signal may vary between different types of elevators, however, it is beneficial that the maintenance person can use the same sequence every time. Thus, the person may be sure that different sounds are not resulting from different sequence but actually from loose joints. This excitement of pulsating or oscillating movement can be repeated as long as the drive and motor are capable of producing such excitement. Thus, the maintenance person can learn the excitement and is able to hear the differences better.

The embodiment of FIG. 1 involves a special configuration in the controller 13, wherein the controller is able to receive the instructions for the excitement signal from an external device, such as a computer connected to the elevator as described above, a memory stick, a memory card or a similar device.

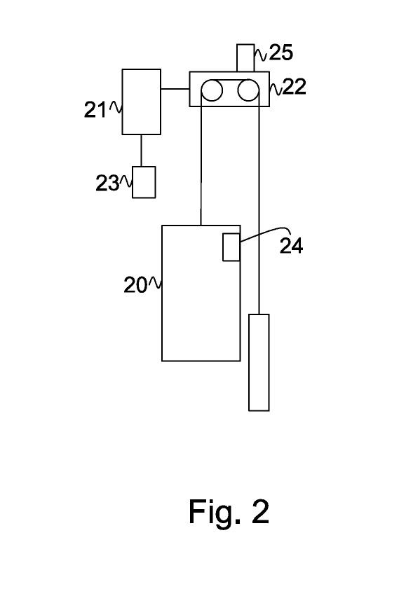

FIG. 2 discloses a further embodiment, wherein a measurement devices 25 and 26 are connect to the elevator car 20 and hoisting installation 22 respectively. The measurement device 25 located in the car is connected to the controller 21 either wirelessly or fixedly. Wireless connection corresponds with the arrangement of FIG. 1. The network switch 23 is used for receiving the instructions and the connection may involve the use of local area network or mobile network. When the measurement device 24 is a fixed part of the elevator car it may use also fixed connection arranged in the elevator shaft. The measurement device 25 connected to the hoisting installation 22 is typically connected to the controller 22 fixedly as it can be easily arranged.

In the embodiment of FIG. 2 two fixed measurement devices 24 and 25 are disclosed, however, the number of the measurement devices is not limited to this number. There may be only one measurement device or more than two. Furthermore, the measurement devices need not to be fixed to the elevator car 10 or hoisting installation 22 but a portable device may be used. Measurement devices are configured to measure the noises, vibrations, oscillations or similar caused by loose joints. The measured data can then be viewed by a maintenance person and the analysis is not dependent on the personal observation skills of the maintenance person. The measured data may be combined with other measurements, such as the speed, acceleration, moved distance, floors and similar. The additional information may help the maintenance person to localize loose joints better. As the measurement devices 24 and 25 are connected to the network switch the collected data can be easily transmitted to a personal computer, work station, portable computer, tablet or any other computing device that facilitates analysis. The analysis needs not to be made on site, however, it might be beneficial as the maintenance person may detect a possible need for additional testing based on that data.

In an embodiment of the invention the measurement device 24 is the microphone of a telephone of the elevator. Typically an elevator comprises a telephone for emergency use. This telephone comprises always a microphone for communication. This microphone can be used for testing purposes according to the present invention. It is acknowledged that an elevator may comprise more than one elevator phone for different uses, or there may be a special purpose microphone or a connector for a microphone in the elevator. The person testing the elevator is free to choose which microphones are used for measurements. However, it is emphasized that the test can also be made without recording the run with microphone or accelerometer using only human senses for observations or by using a portable measuring device having microphone.

A person having ordinary skill understands that the elevator causes all kinds of sounds and noises when moving. The purpose of the present invention is to cause noises and sounds that deviate from the normal sounds and noises that are caused when everything is in order. These undesired noises must be separated from normal noises. This may be done, for example, by a maintenance person who listens the produced sound or by machine. In the machine separation the undesired noise is separated from the normal noise, for example, by comparing the noise with a previously stored model or sample, by searching patterns that typically represent undesired noises, or any similar sound processing method. Furthermore, if a machine detects a possible source of problems in the noise the sample may be sent to a maintenance person for final approval.

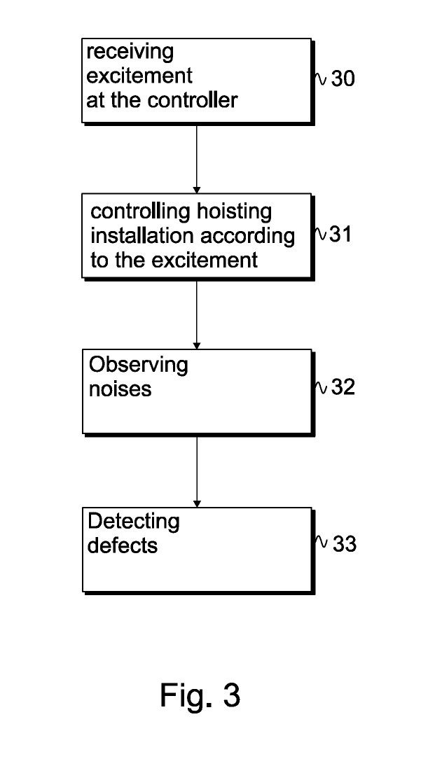

In FIG. 3 a method according to the present invention is disclosed. In the method an excitation signal is first received, step 30. The excitation signal is a signal that causes the elevator to move in a manner that purposively deviates from the movement in normal operation. Examples of such signal are given later. The purpose of the excitation signal is to cause movements, such as vibrations, that correspond with movements caused by a separate shaker device. In the embodiment the excitation signal is received at the controller. For example, the maintenance person uses a special purpose device for transmitting the signal to the controller with appropriate identification. It is noted that even if the excitation signal is transmitted by the maintenance person in the example of FIG. 3, it might be stored also earlier. For example, on or more excitement signals may be stored in the controlling equipment during manufacturing or it might have been loaded during the previous maintenance and store for later used. Thus, the person skilled in the art understands that the transmitting step is not necessary if the excitation signal has already been stored in a device capable of controlling the movement of the elevator to be tested. When the excitement signal has been received at the controller, it sends instructions to the hoisting installation according to the excitation signal, step 31. The excitation signal cause pulsating and/or oscillating movement of the elevator car. The purpose of this movement is that loose joints, material defects, installation defects and other defects cause noises when excited with the excitation signal. These noises are then observed, step 32. The observation may be made by a human, such a maintenance person, who is then able to find the sources of noises, step 33. Furthermore, it is possible to use measuring equipment, such as one or more microphones for detecting noises and finding the sources. The measured information is not used as a feedback during the test run but the elevator is controlled in accordance with the excitation signal, however, the feedback may be used in special testing if it is regarded necessary.

Above discussed excitation signal is combined with an ordinary movement control signal controlling the movements of the elevator to be tested. It must be understood that this combination may be done in different ways. For example, the elevator may comprise a test mode, wherein the excitation signal is transferred to the controller or retrieved from the memory. Then, when a maintenance person calls a journey it is combined with the control signal so that the excitation causes abnormal movements during the journey. In another embodiment the excitation is combined with a control signal before it is transferred to the control. For example, a maintenance person may have a test signal where the control signal part comprises a journey call from first floor to fourth floor and excitation signal part comprises test specific excitation causing abnormal movements that may cause noises and vibrations when defects exist.

The above discussed excitation signal may be, for example white or pink noise, which may be filtered by using a low pass filter, high pass filter or band pass filter. Typically the frequency of wave components is more than 0.5 Hz.

In an embodiment the controller, or a controlling device, controlling at least one elevator is an apparatus comprising at least one processor and at least one memory. The memory includes computer program code for one or more programs, the at least one memory and the computer program code are working together, with the at least one processor, cause the apparatus to perform the above disclosed combination of movement control signal and excitation signal in order to cause movements deviating from the normal movement of the elevator by using the hoisting installation of the elevator.

The above mentioned method may be implemented as computer software which is executed in a controller of an elevator or a computing device able to instruct such controller. When the software is executed in a computing device it is configured to perform the above described inventive method in order to facilitate discovery resources in a mobile communication network. The software is embodied on a computer readable medium so that it can be provided to the computing device.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the invention may be implemented in various ways. The invention and its embodiments are thus not limited to the examples described above; instead they may vary within the scope of the claims.

1. A method for testing an elevator which method comprises the steps of:
controlling the movement of an elevator in accordance with a test signal, wherein the test signal is formed by combining a movement control signal and an excitation signal, wherein said excitation signal comprises an excitement causing pulsating and/or oscillating movement of the elevator car of said elevator by using the hoisting installation of said elevator; and
detecting noises caused by defects during the excitation.

2. The method according to claim 1, wherein detecting noises by human inspection.

3. The method according to claim 1, wherein detecting noises by external measuring devices attached to hoisting installation and/or elevator car.

4. The method according to claim 3, wherein using the microphone of an elevator phone as external measuring device.

5. The method according to claim 1, wherein moving the elevator by variable frequency drive and electric motor.

6. The method according to claim 1, wherein said defects are manufacturing, installation, assembly, maintenance or wearing defects.

7. The method according to claim 1, wherein said excitation signal is white or pink noise, which is filtered with low pass filter, high pass filter or band pass filter.

8. The method according to claim 1, wherein the frequency of wave components of said excitement signal is at least 0.5 Hz.

9. An elevator comprising:
a hoisting installation; and
an elevator car;
wherein the hoisting installation is configured to control the movement of the elevator in accordance with a test signal, wherein the test signal is formed by combining a movement control signal and an excitation signal and further configured to cause pulsating and/or oscillating movement of the elevator car of said elevator in accordance with said test signal.

10. The elevator according to claim 9, wherein said elevator further comprises a control unit connected to the hoisting installation, wherein the control unit is configured to receive said excitation from an external device and further configured to instruct hoisting installation.

11. The elevator according to claim 9, wherein the elevator further comprises at least one external measurement device, wherein said measurement device is configured to detect noises.

12. The elevator according to claim 11, wherein said external measurement device is the microphone of a phone of the elevator.

13. The elevator according to claim 9, wherein the elevator further comprises variable frequency drive and electric motor.

14. The elevator according to claim 9, wherein said excitation signal is white or pink noise, which is filtered with low pass filter, high pass filter or band pass filter.

15. The elevator according to claim 9, wherein the frequency of wave components of said excitement signal is at least 0.5 Hz.

16. The elevator system, wherein the elevator system comprises at least one elevator according to claim 9.

17. The elevator system according to claim 16, wherein the elevator system further comprises an external portable measurement device.

18. The elevator system according to claim 16, wherein said elevator system further comprises an apparatus comprising at least one processor and at least one memory, wherein said at least one memory includes computer program code for one or more programs, said least one memory and said computer program code are working together, with the at least one processor, cause the apparatus to perform the method according to claim 1.

19. A computer program comprising code adapted to cause the following when executed on a data-processing system:
controlling the movement of an elevator in accordance with an excitation signal, wherein said excitement signal comprises instructions for causing pulsating and/or oscillating movement of the elevator car of an elevator by using; and
instructing the hoisting installation of said elevator to cause said pulsating and/or oscillating movement.

20. The computer program according to claim 16, wherein the computer program is further configured to cause following: receiving measurement results from at least one measurement device.
